(19) United States
(12) Patent Application Publication
(10) Pub. No.: US 2026/0281299 A1
(43) Pub. Date: Sep. 17, 2026

(54) ADAPTIVE EYE RELIEF VERIFICATION AND NEW MAPPING FOR VIDEO SEE-THROUGH (VST) EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/540,446

(22) Filed: Feb. 13, 2026

Related U.S. Application Data
(60) Provisional application No. 63/770,187, filed on Mar. 11, 2025.

(51) Int. Cl. H04N 13/344; G06F 3/01; G06V 40/18

(52) U.S. Cl. CPC H04N 13/344; G06F 3/013; G06V 40/18

(57) ABSTRACT

A method includes initiating display of guidance for a user to focus on an object displayed on at least one display device of an electronic device. The method also includes obtaining (i) first image frames using at least two imaging sensors of the electronic device, (ii) first data using at least one eye-tracking sensor of the electronic device, and (iii) second data using at least one object tracking camera of the electronic device. The method further includes determining an actual eye relief distance of the user between (i) a lens of the at least one display device and (ii) a center of a pupil of an eye of the user. The actual eye relief distance is based on the first image frames, first data, and second data. In addition, the method includes determining whether the actual eye relief distance matches a specified eye relief distance of the electronic device.

### CROSS-REFERENCE TO RELATED APPLICATION AND PRIORITY CLAIM

This application claims priority under 35 U.S.C. § 119 (e) to U.S. Provisional Patent Application No. 63/770,187 filed on Mar. 11, 2025, which is hereby incorporated by reference in its entirety.

### TECHNICAL FIELD

This disclosure relates generally to image processing systems and processes. More specifically, this disclosure relates to adaptive eye relief verification and new mapping for video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to adaptive eye relief verification and new mapping for video see-through (VST) extended reality (XR) or other applications.

In a first embodiment, a method includes initiating, using at least one processing device of an electronic device, display of guidance for a user to focus on an object displayed on at least one display device of the electronic device. The method also includes obtaining, using the at least one processing device, (i) first image frames using at least two imaging sensors of the electronic device, (ii) first data using at least one eye-tracking sensor of the electronic device, and (iii) second data using at least one object tracking camera of the electronic device. The method further includes determining, using the at least one processing device, an actual eye relief distance of the user between (i) a lens of the at least one display device and (ii) a center of a pupil of an eye of the user, where the actual eye relief distance is based on the first image frames, the first data, and the second data. In addition, the method includes determining, using the at least one processing device, whether the actual eye relief distance matches a specified eye relief distance of the electronic device.

In a second embodiment, an electronic device includes at least one processing device configured to initiate display of guidance for a user to focus on an object displayed on at least one display device of the electronic device. The at least one processing device is also configured to obtain (i) first image frames using at least two imaging sensors of the electronic device, (ii) first data using at least one eye-tracking sensor of the electronic device, and (iii) second data using at least one object tracking camera of the electronic device. The at least one processing device is further configured to determine an actual eye relief distance of the user between (i) a lens of the at least one display device and (ii) a center of a pupil of an eye of the user, where the actual eye relief distance is based on the first image frames, the first data, and the second data. In addition, the at least one processing device is configured to determine whether the actual eye relief distance matches a specified eye relief distance of the electronic device.

In a third embodiment, a non-transitory machine readable medium contains instructions that when executed cause at least one processor of an electronic device to initiate display of guidance for a user to focus on an object displayed on at least one display device of the electronic device. The non-transitory machine readable medium also contains instructions that when executed cause the at least one processor to obtain (i) first image frames using at least two imaging sensors of the electronic device, (ii) first data using at least one eye-tracking sensor of the electronic device, and (iii) second data using at least one object tracking camera of the electronic device. The non-transitory machine readable medium further contains instructions that when executed cause the at least one processor to determine an actual eye relief distance of the user between (i) a lens of the at least one display device and (ii) a center of a pupil of an eye of the user, where the actual eye relief distance is based on the first image frames, the first data, and the second data. In addition, the non-transitory machine readable medium contains instructions that when executed cause the at least one processor to determine whether the actual eye relief distance matches a specified eye relief distance of the electronic device.

Any one or any combination of the following features may be used with the first, second, or third embodiment.

In response to a determination that the actual eye relief distance does not match the specified eye relief distance, the user may be provided with an alert of an eye relief distance change, and the user may be provided with guidance for adjusting the actual eye relief distance. After an adjustment of the actual eye relief distance, the actual eye relief distance may be determined, and a determination can be made whether the redetermined actual eye relief distance matches the specified eye relief distance.

In response to a determination that the redetermined actual eye relief distance does not match the specified eye relief distance, a mapping may be performed between at least one position of the at least two imaging sensors and at least one eye position of the user based on the actual eye relief distance, a transformation may be performed based on the mapping for viewpoint matching and parallax correction of the first image frames to generate transformed image frames, and display of at least one rendered image may be initiated on the at least one display device. The at least one rendered image may be based on the transformed image frames.

In response to a determination that the actual eye relief distance matches the specified eye relief distance, a mapping may be performed between at least one position of the at least two imaging sensors and at least one eye position of the user based on the specified eye relief distance, a transformation may be performed based on the mapping for viewpoint matching and parallax correction of the first image frames to generate transformed image frames, and display of at least one rendered image may be initiated on the at least one display device. The at least one rendered image may be based on the transformed image frames.

Gaze vectors of a left eye and a right eye of the user may be determined based on the first data, and a determination can be made whether the user is focusing on the object based on the gaze vectors. The actual eye relief distance may be determined in response to a determination that the user is focusing on the object.

Gaze vectors of a left eye and a right eye of the user may be determined based on the first data, and a position of the object can be determined based on the second data. The actual eye relief distance may be determined based on the gaze vectors and the position of the object.

A focal distance of the left and right eyes of the user to the object may be determined based on the gaze vectors and the second data.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2A and 2B illustrate an example technique for adaptive eye relief determination based on eye tracking in accordance with this disclosure;

FIG. 3 illustrates a portion of an example extended reality (XR) headset for illuminating a user's eye in accordance with this disclosure;

FIG. 4 illustrates an example process for adaptive eye relief determination and device adjustment for XR or other applications in accordance with this disclosure;

FIGS. 5A through 5C illustrate example functions in the process of FIG. 4 in accordance with this disclosure;

FIG. 6 illustrates an example architecture supporting adaptive eye relief verification and device adjustment for XR or other applications in accordance with this disclosure;

FIGS. 7A and 7B illustrate an example technique for gaze distance determination based on eye focal point tracking in accordance with this disclosure;

FIG. 8 illustrates an example technique for computing eye relief changes in accordance with this disclosure;

FIGS. 9 and 10 illustrate example relationships between virtual images and eye relief in accordance with this disclosure;

FIG. 11 illustrates an example technique for mapping between a see-through camera and a virtual camera with an eye relief change in accordance with this disclosure; and

FIGS. 12A and 12B illustrate an example method for adaptive eye relief verification and new mapping for VST XR or other applications in accordance with this disclosure.

### DETAILED DESCRIPTION

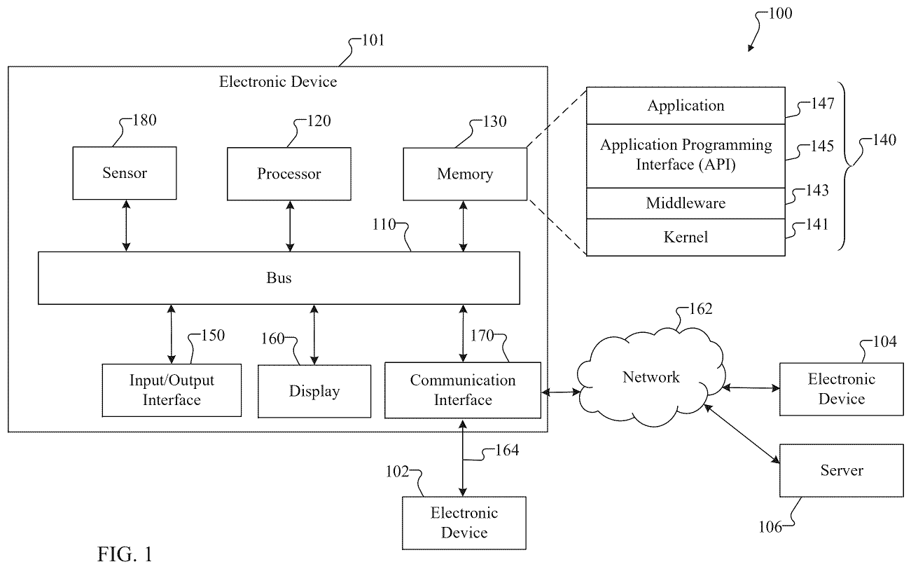

FIGS. 1 through 12B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality. A VST XR device often includes one or more imaging sensors (also called “see-through cameras”) that capture high-resolution image frames of a user's surrounding environment. These image frames are processed in an image processing pipeline in order to generate final rendered views of the user's surrounding environment.

Eye relief can be useful or important in designing and using XR devices and in a number of other applications. Eye relief refers to the distance from the center of a pupil of a person's eye to a first element in an optical system. For example, in the case of an XR device, eye relief may refer to the distance between the center of a pupil of a person's eye and a lens of a display. Often times, each individual user's eye relief needs to be known so that an XR device can be adjusted for use by that individual user. Among other things, this may allow each user to see correct final views generated by that user's XR device.

This disclosure provides various techniques supporting adaptive eye relief verification and new mapping for VST XR. As described in more detail below, display can be initiated of guidance for a user to focus on an object displayed on at least one display device of an electronic device. First mage frames can be obtained using at least two imaging sensors, first data can be obtained using at least one eye-tracking sensor, and second data can be obtained using at least one object tracking camera. An actual eye relief distance of the user can be determined between (i) a lens of the at least one display device and (ii) a center of a pupil of an eye of the user, where the actual eye relief distance is based on the first image frames, the first data, and the second data. A determination can be made whether the actual eye relief distance matches a specified eye relief distance of the electronic device. If needed or desired, the user can be provided with an alert of an eye relief distance change and with guidance for adjusting the actual eye relief distance. After an adjustment of the actual eye relief distance, the actual eye relief distance can be redetermined, and a determination can be made whether the redetermined actual eye relief distance matches the specified eye relief distance. Different mappings and transformations may be performed based on whether the redetermined actual eye relief distance matches or does not match the specified eye relief distance.

In this way, the disclosed techniques provide an efficient mechanism to determine the eye relief of a user and optionally to make adjustments to a device worn by the user based on the determined eye relief. This may allow, for example, more efficient configuration of XR headsets or other devices worn by users since their eye relief can be determined and their devices can be adjusted in a convenient and accurate (and possibly automated) manner. Moreover, a pipeline used in an XR device can be designed to implement changes to rendered images based on the eye relief of the user currently using the XR device, such as by creating mappings and performing transformations to generate final view images. Overall, these techniques can significantly increase the accuracy and decrease the difficulty of determining eye relief distances and adjusting XR devices or other devices based on the eye relief distances.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to adaptive eye relief verification and new mapping for VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform adaptive eye relief verification and new mapping for VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to adaptive eye relief verification and new mapping for VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

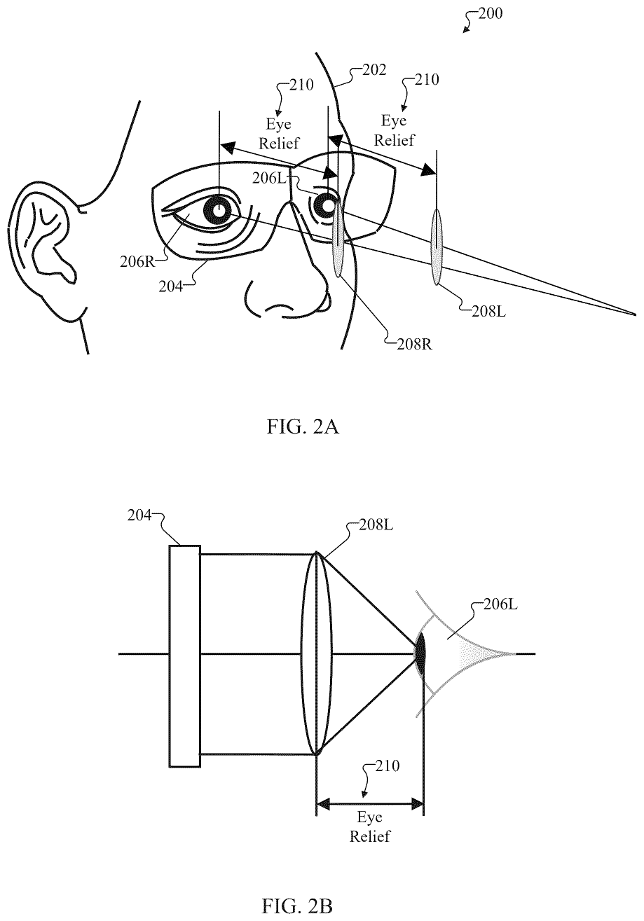

FIGS. 2A and 2B illustrate an example technique 200 for adaptive eye relief determination based on eye tracking in accordance with this disclosure. For ease of explanation, the technique 200 shown in FIGS. 2A and 2B is described as being performed using or as involving the use of the electronic device 101 in the network configuration 100 shown in FIG. 1. However, the technique 200 may be performed using any other suitable device(s) and in any other suitable system(s).

As shown in FIGS. 2A and 2B, a user 202 is wearing a headset 204, which can represent one example implementation of the electronic device 101. In this example, the headset 204 takes the form of smart glasses. However, the headset 204 may have any other suitable form. The user 202 here is focusing his or her left eye 206L on a display lens 208L. The display lens 208L is located at a distance 210 from the eye 206L, which represents the actual eye relief of the user's left eye 206L. The user 202 here is also focusing his or her right eye 206R on a display lens 208R. The display lens 208R is located at a distance 210 from the eye 206R, which represents the actual eye relief of the user's right eye 206R. The headset 204 can include various sensors, such as eye-tracking sensors. The eye-tracking sensors can be used to estimate where the user is gazing. For example, the eye-tracking sensors may be used to identify a focal point for one or more of the user's eyes 206L and 206R, a focal distance d_{f} for one or more of the user's eyes 206L and 206R, an eye gaze direction for one or more of the user's eyes 206L and 206R, or any suitable combination thereof.

As described in more detail below, information from the eye-tracking sensors can be used to determine the actual eye relief distance 210 of the user's eyes 206L and 206R. For example, with an adequately-accurate measure of a focal distance of the user's eyes 206L and 206R, it is possible to derive the actual eye relief distance 210 of the user's eyes 206L and 206R. As a particular example, the eye-tracking sensors can capture eye-tracking data (such as high-resolution or other image frames) while the user 202 is focusing his or her eyes 206L and 206R on a target point. The target point may represent a point or object within a real-world scene or a point of a checkerboard pattern or other pattern/object/point artificially created and displayed to the user 202. The captured eye-tracking data can be used to obtain an accurate estimate of the user's focal distance. From this, an accurate measurement of the user's actual eye relief distance 210 can be determined. Details of example approaches for determining the user's actual eye relief distance 210 are provided below.

Although FIGS. 2A and 2B illustrate one example of a technique 200 for adaptive eye relief determination based on eye tracking, various changes may be made to FIGS. 2A and 2B. For example, as noted above, the headset 204 may have any other suitable form. Also, the display lenses 208L and 208R may be positioned at any suitable eye relief distance(s) 210 from the user 202.

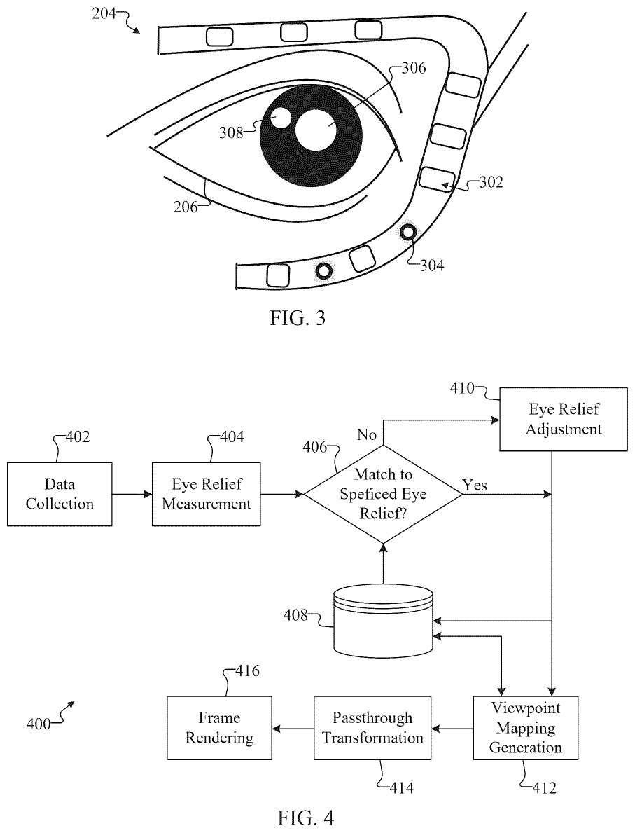

FIG. 3 illustrates a portion of an example XR headset 204 for illuminating a user's eye 206L or 206R in accordance with this disclosure. For ease of explanation, the headset 204 shown in FIG. 3 is described as being one example implementation of the electronic device 101 in the network configuration 100 shown in FIG. 1, where the headset 204 may be used as part of the technique 200 shown in FIGS. 2A and 2B. However, the headset 204 may be used in any other suitable system(s) and with any other suitable technique(s), and the electronic device 101 may be implemented in any other suitable manner.

As shown in FIG. 3, the XR headset 204 includes one or more illumination sources 302 and one or more eye-tracking imaging sensors 304. Each illumination source 302 is configured to generate illumination that can be directed at a user's eye 206L or 206R. Each illumination source 302 can generate any suitable illumination, such as infrared illumination. Note that the number and positions of the illumination sources 302 shown in FIG. 3 are for illustration only. The XR headset 204 may include any suitable number of illumination sources 302, and the illumination source(s) 302 may be positioned at any suitable location(s). Each illumination source 302 represents any suitable structure configured to generate illumination for a user's eye 206L or 206R, such as an infrared or other light emitting diode (LED).

Each eye-tracking imaging sensor 304 is configured to capture one or more image frames of the user's eye 206L or 206R. The illumination from the illumination source(s) 302 can reflect from the user's eye 206L or 206R, and these reflections can be captured in the image frames obtained using the eye-tracking imaging sensor(s) 304. In some cases, for instance, the illumination from the illumination source(s) 302 can create a reflection 306 from the pupil of the user's eye 206L or 206R and one or more reflections 308 from the cornea of the user's eye 206L or 206R.

Each eye-tracking imaging sensor 304 can capture image frames of the user's eye 206L or 206R that include at least some of these reflections 306, 308. The locations of these reflections 306, 308 can be used by the XR headset 204 to identify a gaze direction or other information about where the user 202 is gazing. For instance, it is possible to analyze vectors between the pupil and corneal reflections 306, 308 to measure the gaze direction, focal point, and/or focal distance of the user's eyes 206L and 206R. Each eye-tracking imaging sensor 304 includes any suitable structure configured to capture image frames of a user's eye 206L or 206R, such as an infrared or other camera. In some cases, the eye-tracking imaging sensors 304 may represent imaging sensors 180 of the electronic device 101.

Although FIG. 3 illustrates one portion of an example XR headset 204 for illuminating a user's eye 206L or 206R, various changes may be made to FIG. 3. For example, the XR headset 204 may have any other suitable form factor. Also, the arrangement shown in FIG. 3 can be duplicated on the opposite side of the XR headset 204, meaning each eye 206L and 206R of the user 202 may be illuminated using one or more illumination sources 302 and imaged using one or more eye-tracking imaging sensors 304.

FIG. 4 illustrates an example process 400 for adaptive eye relief determination and device adjustment for XR or other applications in accordance with this disclosure. For ease of explanation, the process 400 shown in FIG. 4 is described as being performed using or as involving the use of the electronic device 101 in the network configuration 100 shown in FIG. 1, where the electronic device 101 may have the form shown in FIGS. 2 and 3. However, the process 400 may be performed using any other suitable device(s) and in any other suitable system(s).

As shown in FIG. 4, the process 400 includes a data collection operation 402, which generally operates to obtain image frames captured by the headset 204 or other electronic device 101. The obtained image frames can include image frames of a scene captured by forward-facing or other imaging sensors 180 of the electronic device 101. In some cases, these image frames may represent high-resolution color image frames. The obtained image frames can also include image frames of the user's eyes 206L and 206R captured by the eye-tracking imaging sensors 304 of the electronic device 101. In some cases, these image frames may also represent high-resolution color image frames. The image frames of the user's eyes 206L and 206R can be captured while the user 202 is focusing on a point, object, or pattern within the scene being viewed. In some embodiments, the point or object may be associated with an actual object within a scene. In other embodiments, the point, object, or pattern may be artificially created and displayed. In addition, the data collection operation 402 may optionally obtain other information, such as depth data captured using one or more depth sensors of the electronic device 101. Any suitable pre-processing of the obtained data may be performed here.

An eye relief measurement operation 404 generally operates to process image frames and optionally other information obtained by the data collection operation 402 in order to determine the eye relief distance of the user 202. For example, the eye relief measurement operation 404 can use eye-tracking data to compute the focal point, focal distance, and/or gaze direction of the user 202 while the user's eyes 206L and 206R are focused. As a particular example, the eye relief measurement operation 404 can use the pupil and corneal reflections 306, 308 captured in the image frames of the user's eyes 206L and 206R in order to estimate the focal distance of the user's eyes 206L and 206R. Based on the focal distance and other information, the eye relief measurement operation 404 can determine the actual eye relief distance 212L and/or 212R of the user 202. Additional details regarding example techniques for determining the user's eye relief are provided below.

A comparison operation 406 generally operates to compare the actual eye relief determined by the eye relief measurement operation 404 with a specified eye relief of the electronic device 101. For example, the specified eye relief may correspond to a designed eye relief of the electronic device 101 or with a previously-saved eye relief setting of the electronic device 101, which may be stored in a database 408 or other suitable storage. If the actual eye relief determined by the eye relief measurement operation 404 is not the same as or similar to the specified eye relief of the electronic device 101 (such as when they differ by at least a threshold amount or percentage), an eye relief adjustment operation 410 can be performed.

The eye relief adjustment operation 410 generally operates to adjust the eye relief of the electronic device 101 to match a designed eye relief of the electronic device 101. For instance, in some embodiments, the electronic device 101 may provide audible and/or visual cues to alert the user that a present eye relief does not match the designed eye relief. The electronic device 101 may also provide audible and/or visual cues to assist the user in adjusting the position and/or instruction on how an adjustment mechanism of the electronic device 101 can be used to adjust the position(s) of one or more display lenses or other component(s) of the electronic device 101 to correspond with the designed eye relief of the electronic device 101. Also or alternatively, the electronic device 101 may include one or more digital motors or other actuator(s) configured to adjust the position(s) of one or more display lenses or other component(s) of the electronic device 101. This allows the electronic device 101 to be manually or automatically adjusted based on the actual eye relief determined by the eye relief measurement operation 404. An updated eye relief setting of the electronic device 101 can also be stored in the database 408 or other storage for subsequent use.

A viewpoint mapping generation operation 412 generally operates to produce one or more mappings that can be used to match or substantially match the viewpoint(s) of the imaging sensor(s) 180 used to capture the image frames of the scene around the user 202 (often referred to as see-through camera(s)) and the viewpoints of the user's eyes 206L and 206R. A passthrough transformation operation 414 generally operates to apply the one or more mappings to the image frames of the scene as captured by the see-through camera(s). For example, the viewpoint mapping generation operation 412 and the passthrough transformation operation 414 can be used to compensate for things like registration and parallax errors, which may be caused by factors like differences between the positions of the see-through camera(s) and the user's eyes 206L and 206R. As particular examples, the viewpoint mapping generation operation 412 may identify and the passthrough transformation operation 414 may apply a rotation and/or a translation to each image frame of the scene around the user 202 captured using the see-through camera(s) in order to compensate for these or other types of issues. Ideally, the transformations give the appearance that the image frames captured at the location(s) of the see-through camera(s) were actually captured at the locations of the user's eyes 206L and 206R. Often times, the rotation and/or translation can be derived mathematically based on the position and angle of each see-through camera and the expected or actual positions of the user's eyes 206L and 206R. In some cases, the transformations are static (since these positions and angles will not change), allowing passthrough transformations to be applied quickly.

In some embodiments, the one or more mappings generated by the viewpoint mapping generation operation 412 may be stored in the database 408 in association with the designed eye relief or a previously-saved eye relief setting of the electronic device 101. If the determined eye relief of the electronic device 101 corresponds with the designed eye relief (or a previously-saved eye relief setting) of the electronic device 101, the one or more stored mappings may be retrieved and applied by the passthrough transformation operation 414 without recalculation by the viewpoint mapping generation operation 412. However, this is not necessarily required, and the viewpoint mapping generation operation 412 may generate one or more mappings each time the eye relief of the electronic device 101 is determined.

A frame rendering operation 416 generally operates to create final views of the scene captured in the transformed image frames generated by the passthrough transformation operation 414. The frame rendering operation 416 can also render the final views for presentation to a user of the electronic device 101. For example, the frame rendering operation 416 may process the transformed image frames and perform any additional refinements or modifications needed or desired, and the resulting images can represent the final views of the scene. For instance, a 3D-to-2D warping can be used to warp the final views of the scene into 2D images. The frame rendering operation 416 can also present the rendered images to the user. For example, the frame rendering operation 416 can render the images into a form suitable for transmission to at least one display 160 and can initiate display of the rendered images, such as by providing the rendered images to one or more displays 160. In some cases, there may be a single display 160 on which the rendered images are presented for viewing by the user 202, such as where each eye 206L and 206R of the user 202 views a different portion of the display 160. In other cases, there may be separate displays 160 on which the rendered images are presented for viewing by the user 202, such as one display 160 for each of the user's eyes 206L and 206R.

Although FIG. 4 illustrates one example of a process 400 for adaptive eye relief determination and device adjustment for XR or other applications, various changes may be made to FIG. 4. For example, various components or functions in FIG. 4 may be combined, further subdivided, replicated, omitted, or rearranged and additional components or functions may be added according to particular needs.

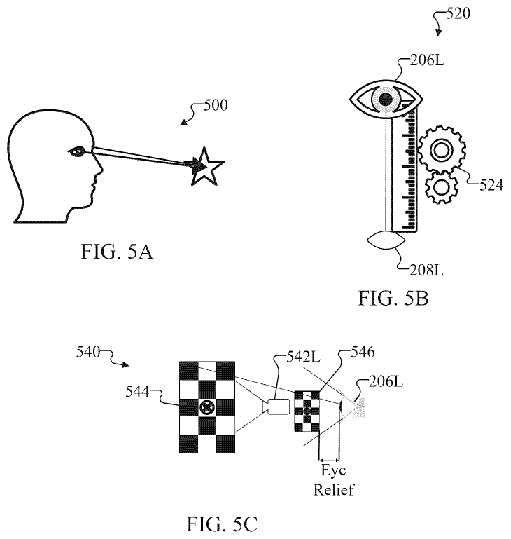

FIGS. 5A through 5C illustrate example functions in the process 400 of FIG. 4 in accordance with this disclosure. As shown in FIG. 5A, one operation associated with the process 400 is an eye relief measurement operation 500, which may occur as part of the eye relief measurement operation 404. During the operation 500, the electronic device 101 can process image frames capturing the user's eyes 206L and 206R. Using suitable image processing and other processing, the electronic device 101 can measure the actual eye relief distance 210 or other parameters of the user's gaze while the user is focusing on a point, object, or pattern in a scene. The electronic device 101 can use a focal distance or other parameters of the user's gaze to estimate the user's eye relief 210.

As shown in FIG. 5B, another operation that may be associated with the process 400 is a device adjustment operation 520, which may occur as part of the eye relief adjustment operation 410. During the operation 520, the user or the electronic device 101 can adjust the positions of display lenses 208L and 208R of the electronic device 101. Each display lens 208L and 208R can be positioned between one of the user's eyes 206L and 206R and at least one display 160 of the electronic device 101. Ideally, the display lenses 522 can be centered on the user's eyes 206, meaning the optical axis of each display lens 522 is aligned with the center of the pupil of the associated eye 206. As a result, the actual eye relief of the user 202 can be used to adjust the positions of the display lenses 522, such as by decreasing the distance 210 between display lenses 208L and 208R and the user's eyes 206L and 206R when the actual eye relief of the user 202 is larger than the specified eye relief of the electronic device 101 or decreasing the distance 210 between display lenses 208L and 208R and the user's eyes 206L and 206R when the actual eye relief of the user 202 is smaller than the specified eye relief of the electronic device 101.

The positions of the display lenses 208L and 208R may be controlled in any suitable manner. For example, the electronic device 101 may include one or more actuators 524L, such as one or more manual controls or digital motors. The processor 120 of the electronic device 101 may identify the actual eye relief distance of the user 202 currently using the electronic device 101 and control or guide the user to control the one or more actuators 524 to alter the positions of the display lenses 208L and 208R based on that actual eye relief distance. In some cases, the processor 120 may initiate a visual, audible, or other alert or other notification informing the user 202 of the change in the positions of the display lenses 208L and 208R prior to causing the one or more actuators 524 to alter the positions of the display lenses 208L and 208R.

As shown in FIG. 5C, yet another operation that may be associated with the process 400 is a transformation operation 540, which may occur as part of the viewpoint mapping generation operation 412 and the passthrough transformation operation 414. During the operation 540, the electronic device 101 can perform operations like viewpoint matching and parallax correction. These operations can be used since one or more see-through cameras 542 (which may represent one or more forward-facing or other imaging sensors 180 of the electronic device 101) can capture image frames of a scene being viewed by the user 202, but the see-through cameras 542 are positioned at locations different than the locations of the user's eyes 206L or 206R. As a result, the fields of view 544 of the see-through cameras 542 differ from the fields of view 546 of the user's eyes 206L and 206R. The transformation operation 540 can provide viewpoint matching, parallax correction, or other corrections so that the final rendered images presented to the user 202 by the electronic device 101 achieve the desired effects.

Although FIGS. 5A through 5C illustrate examples of functions in the process 400 of FIG. 4, various changes may be made to FIGS. 5A through 5C. For example, the various functions of FIG. 4 show in FIGS. 5A through 5C may be implemented in any other suitable manner.

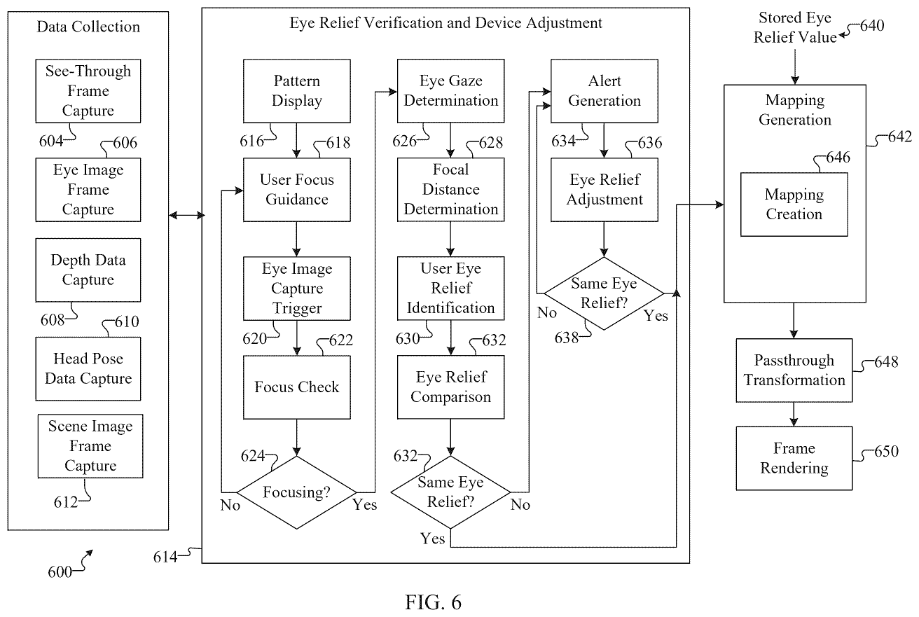

FIG. 6 illustrates an example architecture 600 supporting adaptive eye relief verification and device adjustment for XR or other applications in accordance with this disclosure. For ease of explanation, the architecture 600 shown in FIG. 6 is described as being implemented using the electronic device 101 in the network configuration 100 shown in FIG. 1, where the electronic device 101 may have the form shown in FIGS. 2 and 3 and may implement the process 400 shown in FIG. 4. However, the architecture 600 may be implemented using any other suitable device(s) and in any other suitable system(s), and the architecture 600 may be used to implement any other suitable process(es) designed in accordance with this disclosure.

As shown in FIG. 6, a data capture operation 602 generally operates to obtain image frames and other data used to perform eye relief determination and device adjustment, such as to implement the data collection operation 402. For example, the data capture operation 602 may include a see-through frame capture function 604 and an eye image frame capture function 606. The see-through frame capture function 604 can be used to obtain image frames of a scene to be processed using the architecture 600. These image frames may be obtained using one or more see-through cameras 542 or other imaging sensors 180 of the electronic device 101 to provide the user surrounding views. The eye image frame capture function 606 can be used to obtain image frames of a user's eyes 206L and 206R to be processed using the architecture 600. Those image frames may be obtained using eye-tracking imaging sensors 304. Note that the number of obtained images obtained from the one or more see-through cameras 542 and the number of obtained images obtained from the eye-tracking imaging sensors 304 can vary depending on the implementation.

The data capture operation 602 may also include a depth data capture function 608 and a head pose data capture function 610. The depth data capture function 608 may be used to obtain depth maps or other depth data associated with the image frames captured using the see-through cameras 542 or other imaging sensors 180 of the electronic device 101. If the depth data capture function 608 is used, the depth data may be obtained from any suitable source(s), such as from one or more depth sensors 180 (like one or more LIDAR or time-of-flight depth sensors) of the electronic device 101. The head pose data capture function 610 may be used to obtain information identifying the pose of the user's head while the electronic device 101 is being used. If the head pose data capture function 610 is used, the head pose data may be obtained from any suitable source(s), such as from one or more positional sensors like at least one IMU.

The data capture operation 602 may further include a scene image frame capture function 612. The scene image frame capture function 612 can be used to obtain image frames of a scene with one or more object tracking cameras. For example, the object tracking cameras may be cameras separated from the see-through cameras 542 used to track an object with the obtained image frames for motion tracking and scene reconstruction.

An eye relief verification and device adjustment operation 614 generally operates to determine the user's actual eye relief and (if needed or desired) adjust the eye relief of the electronic device 101, such as to implement the eye relief measurement operation 404, comparison operation 406, and eye relief adjustment operation 410. In this example, the eye relief verification and device adjustment operation 614 includes an optional pattern display function 616. In some embodiments, the electronic device 101 may render and present a pattern or other artificial content on the display(s) 160 of the electronic device 101. The pattern can be displayed to appear at a known focal distance from the perspective of the user 202. The electronic device 101 can capture image frames of the user's eyes 206L and 206R while the user focuses on the pattern and use the image frames to determine the user's actual eye relief distance 210. Any suitable pattern can be used here, such as a checkerboard pattern or a single point. Note, however, that the display of the pattern is optional since the user 202 could focus on an actual object or point within the scene.

A user focus guidance function 618 generally operates to instruct the user 202 to focus on an object, point, or pattern within the images rendered and displayed on the display(s) 160 of the electronic device 101. For example, the user focus guidance function 618 may ask the user 202 to focus his or her gaze at the center of a displayed checkerboard pattern or other pattern or to otherwise focus on an object, point, or pattern within the images rendered and displayed on the display(s) 160. If the user 202 appears to focus on the wrong location or does not focus correctly, the user focus guidance function 618 may give the user 202 guidance or ask the user 202 to focus for a longer period of time. These interactions can occur in any suitable manner, such as when the user focus guidance function 618 causes textual instructions to be displayed to the user 202 on the display(s) 160 and/or causes audible instructions to be presented to the user 202.

An eye image capture trigger function 620 can be used to trigger image capture (and optionally other data capture) by the data capture operation 602. For example, the eye image capture trigger function 620 may wait for a predetermined period of time after an instruction to focus is provided to the user 202, and the eye image capture trigger function 620 can trigger image frame capture by the eye image frame capture function 606 after the predetermined period of time elapses. A focus check function 622 can process the captured image frames and confirm whether it appears the user 202 is focusing as instructed. For instance, the focus check function 622 may use the pupil and corneal reflections 306, 308 to determine whether it appears the user 202 is focusing his or her eyes 206L and 206R inwards towards the displayed pattern or other object, point, or pattern. A focusing determination function 624 can determine whether the focus check function 622 identifies that the user 202 as focusing as instructed. If not, the user focus guidance function 618 can provide the same instructions or other/additional instructions to the user 202 so that the user 202 can change his or her focus.

Assuming the user 202 focuses as instructed, the image frames captured using the eye image frame capture function 606 can be processed by an eye gaze determination function 626 and/or a focal distance determination function 628. The eye gaze determination function 626 generally operates to estimate the gaze direction(s) of the user's eyes 206, such as based on the reflections 306, 308 of the illumination from the illumination sources 302 on the user's eyes 206. The eye gaze determination function 626 can use any suitable technique to identify the user's gaze direction(s). In some embodiments, for instance, the eye gaze determination function 626 may use a Pupil Center Corneal Reflection (PCCR) technique. Note, however, that any other suitable eye tracking technique(s) may be used here. The eye gaze determination function 626 can also confirm that the identified gaze direction or directions are suitable for further processing, such as by verifying that the user's gaze directions are aimed inward towards the center of a displayed pattern or other suitable object, point, or pattern. If not, the eye gaze determination function 626 could stop and cause control to return to the user focus guidance function 618 for additional user instruction.

The focal distance determination function 628 generally operates to estimate a focal distance d_{f} of the user's eyes 206. The user's focal distance d_{f} represents the distance from the user's eyes 206L and 206R to the point of focus of the user's eyes 206L and 206R (a target point P). In some cases, the user's focal distance d_{f} can be determined by estimating where the gaze directions of the user's eyes 206L and 206R intersect. In other cases, the focal distance determination function 628 can calculate the user's focal distance d_{f} to a designed pattern or other object, point, or pattern based on the pupil and corneal reflections 306, 308. In general, this disclosure is not limited to any specific technique(s) for identifying the user's actual eye relief distance 210.

A user eye relief identification function 630 generally operates to determine the user's actual eye relief distance 210. For example, the user eye relief identification function 6230 may determine the user's actual eye relief distance 210 based on the captured image frames of the user's eyes 206L and 206R, the identified gaze direction(s) of the user's eyes 206L and 206R, and the identified focal distance d_{f}. The user eye relief identification function 630 can use any suitable technique(s) to determine actual eye relief distances, such as the techniques described in more detail below.

A comparison function 632 determines if the actual eye relief distance matches or is substantially similar to the specified eye relief distance of the electronic device 101 (at least to within a threshold amount or percentage). If the determined actual eye relief distance adequately differs from the specified eye relief distance of the electronic device 101, an alert generation function 634 may be used to present an alert to the user 202 indicating that the eye relief of the electronic device 101 is about to change. This alert can be displayed to the user 202 on the display(s) 160 of the electronic device 101, played audibly to the user via one or more speakers of the electronic device 101, or presented in any other suitable manner.

A manual or motor-driven eye relief adjustment function 636 can be used to instruct the user to adjust or to automatically adjust the eye relief of the electronic device 101, such as by controlling the one or more actuators 524 in order to move the display lenses 522 inward or outward depending on the determination of the user's actual eye relief distance. A stored eye relief update function 638 can store a new eye relief setting of the electronic device 101, such as in the database 408 or other suitable storage. If the comparison function 632 determines that the user's actual eye relief distance matches or is substantially similar to the specified eye relief of the electronic device 101, no change to the eye relief of the electronic device 101 may be needed.

One or more stored eye relief values 640 and the current (possibly updated) eye relief setting of the electronic device 101 are provided to a mapping generation operation 642, such as to implement the viewpoint mapping generation operation 412. The current eye relief setting of the electronic device 101 may be the new setting identified by the eye relief verification and device adjustment operation 614 or a designed or specified (unchanged) eye relief setting. The mapping generation operation 642 generally operates to generate or otherwise obtain one or more mappings used to perform passthrough transformations or other modifications to the image frames captured using the one or more see-through cameras 542 or other imaging sensors 180 of the electronic device 101 and obtained by the see-through frame capture function 604. The mapping generation operation 642 includes a stored eye relief retrieval function 644, which can obtain one or more stored eye relief values 640 from the database 408. Each stored eye relief value 640 may be associated with one or more mappings that were previously generated for that stored eye relief value 640.

A mapping creation function 646 generally operates to identify mappings (such as mathematical transformations) between the position(s) of the see-through camera(s) 542 or other imaging sensor(s) 180 of the electronic device 101 and the positions of the user's eyes 206L and 206R. As noted above, in some embodiments, this can involve the identification of translations and/or rotations needed to adjust image frames captured at the position(s) of the see-through camera(s) 542 or other imaging sensor(s) 180 in order to make it appear as if the image frames were captured at the positions of the user's eyes 206L and 206R. Among other things, these mappings can be used to support viewpoint matching and parallax correction.

In some cases, the mappings identified by the mapping creation function 646 may be new mappings, such as one or more mappings generated in response to the specified eye relief of the electronic device 101 not matching any stored eye relief values 640. In other cases, the mappings identified by the mapping creation function 646 may be prior mappings, such as one or more mappings previously generated and stored in the database 408 in association with a specified one of the stored eye relief values 640. In the former case, the mapping creation function 646 may store the new mapping(s) in the database 408 in association with a new eye relief setting of the electronic device 101. In the latter case, the mapping creation function 646 may retrieve the prior mapping(s) from the database 408.

The one or more mappings identified by the mapping generation operation 642 can be provided to a passthrough transformation operation 648. The passthrough transformation operation 648 generally operates to apply the mapping(s) to the image frames captured by the one or more see-through cameras 542 or other imaging sensors 180 of the electronic device 101, such as to implement the passthrough transformation operation 414. The resulting transformed image frames are provided to a frame rendering operation 650. The frame rendering operation 650 generally operates to render the transformed image frames and initiate display of the resulting rendered images, such as to implement the frame rendering operation 416.

Although FIG. 6 illustrates one example of an architecture 600 supporting adaptive eye relief verification and device adjustment for XR or other applications, various changes may be made to FIG. 6. For example, various components, operations, or functions in FIG. 6 may be combined, further subdivided, replicated, omitted, or rearranged and additional components, operations, or functions may be added according to particular needs.

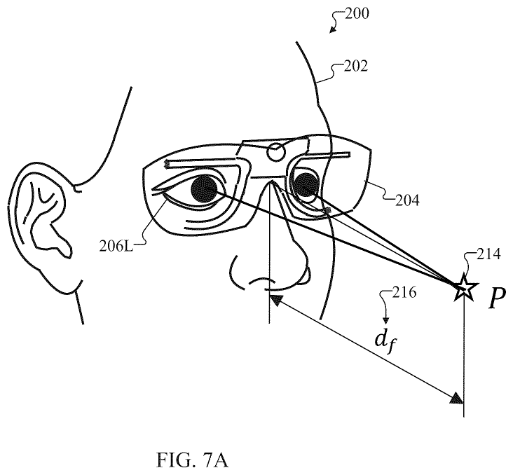

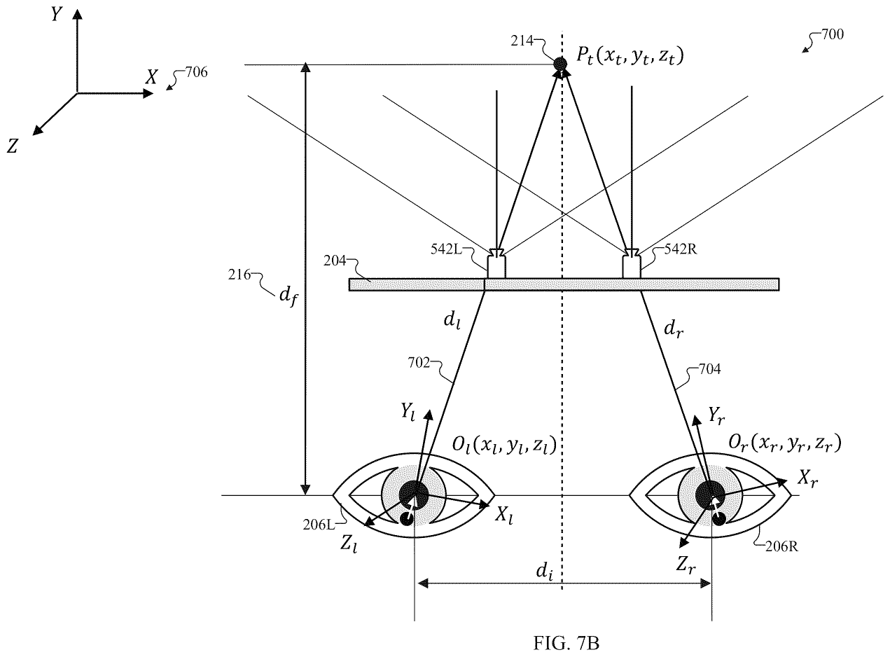

FIGS. 7A and 7B illustrate an example technique 700 for gaze distance determination based on eye focal point tracking in accordance with this disclosure. For ease of explanation, the technique 700 shown in FIGS. 7A and 7B is described as being performed using the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the technique 700 may be performed using any other suitable device(s) and in any other suitable system(s), and the technique 700 may be used to implement any other suitable process(es) and architecture(s) designed in accordance with this disclosure.

As shown in FIGS. 7A and 7B, the user's left eye 206L and the user's right eye 206R are focused inward towards a target point 214. The target point 214 may represent a point on which the user 202 is focused, such as a point in an artificial pattern or a point of an object within the scene being viewed by the user 202. While the user 202 is focusing on the target point 214, the eye-tracking imaging sensors 304 can capture image frames of the user's left and right eyes 206L and 206R. Through suitable image processing (such as by the eye gaze determination function 626), a left gaze vector 702 and a right gaze vector 704 can be identified. The gaze vectors 702, 704 identify the gaze directions for the user's eyes 206L and 206R when focused on the target point 208.

Based on the image frames capturing the user's eyes 206L and 206R, an origin of the user's left eye 206L can be determined, such as by identifying the center of the user's left pupil. The position of the origin of the user's left eye 206L can be expressed as O₁(xₗ, yₗ, zₗ). Similarly, an origin of the user's right eye 206R can be determined, such as by identifying the center of the user's right pupil. The position of the origin of the user's right eye 206R can be expressed as Oᵣ(xᵣ, yᵣ, zᵣ). Using a head motion tracking system (such as in head pose data capture function 610), the electronic device 101 can track the gaze target point Pₜ(xₜ,yₜ,zₜ). Using these coordinates, three points of a triangle ΔOₗOₜPₜ can be obtained and could be defined as follows.

$$\{ \begin{matrix}{O}_{l} ( {x}_{l} , {y}_{l} , {z}_{l} ) \\ {O}_{r} ( {x}_{r} , {y}_{r} , {z}_{r} ) \\ {P}_{t} ( {x}_{t} , {y}_{t} , {z}_{t} )\end{matrix}$$

With the coordinates of these points, distances dᵢ, dₗ, and dᵣ can be computed, such as in the following manner.

$$\{ \begin{matrix}{d}_{i} = \sqrt{{( {x}_{l} - {x}_{r} )}^{2} + {( {y}_{l} - {y}_{r} )}^{2} + {( {z}_{l} - {z}_{r} )}^{2}} \\ {d}_{l} = \sqrt{{( {x}_{l} - {x}_{t} )}^{2} + {( {y}_{l} - {y}_{t} )}^{2} + {( {z}_{l} - {z}_{t} )}^{2}} \\ {d}_{r} = \sqrt{{( {x}_{t} - {x}_{r} )}^{2} + {( {y}_{t} - {y}_{r} )}^{2} + {( {z}_{t} - {z}_{r} )}^{2}}\end{matrix}$$

From this, it is possible (such as by using the focal distance determination function 628) to determine the user's actual focal distance 216 (denoted d_{f} here). In some cases, the user's focal distance 216 can be calculated as ΔOₗO_{y}Pₜ, in the following manner.

$${d}_{f} = \frac{1}{2 {d}_{i}} \sqrt{( {d}_{l} + {d}_{i} + {d}_{r} )} \sqrt{( - {d}_{l} + {d}_{i} + {d}_{r} )} \sqrt{( {d}_{l} - {d}_{i} + {d}_{r} )} \sqrt{( {d}_{l} + {d}_{i} - {d}_{r} )}$$

Note that the user's focal distance 216 might undergo small changes due to slight movements of the user's eyes 206L and 206R. This can be handled in various ways. For example, in some cases, the user 202 may be asked to focus on different target points 214 at different depths, and multiple focal distances 216 can be identified and averaged in order to estimate an average focal distance 216 for the user 202. Thus, for instance, a checkerboard pattern or other pattern may be displayed to the user 202 at different depths within a scene, the user 202 may be asked to focus on a center or other portion of the pattern at each depth within the scene, and the resulting focal distances can be identified and averaged.

Although FIGS. 7A and 7B illustrate one example of a technique 700 for gaze distance determination based on eye focal point tracking, various changes may be made to FIGS. 7A and 7B. For example, the locations of the user's pupils may be expressed in any other suitable manner, such as when one pupil center is treated as the origin of a coordinate system and the other pupil center is treated as being offset from that origin.

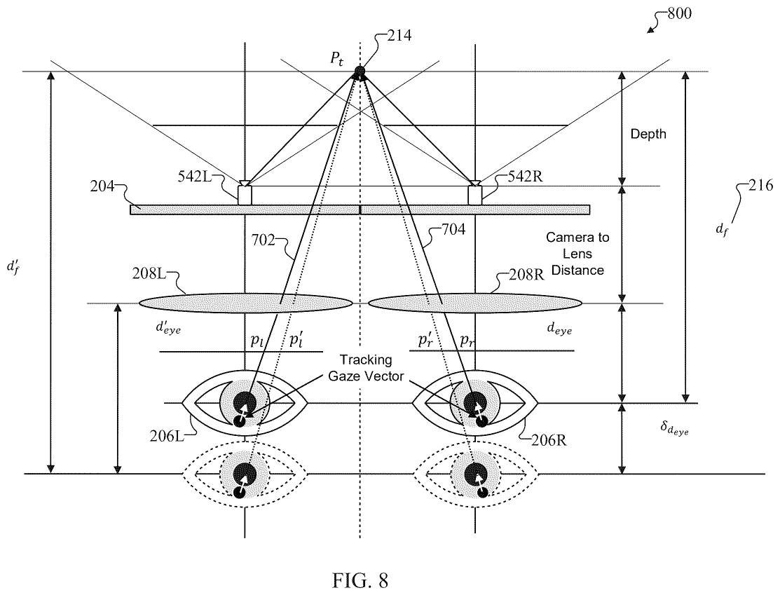

FIG. 8 illustrates an example technique 800 for computing eye relief changes in accordance with this disclosure. For ease of explanation, the technique 800 shown in FIG. 8 is described as being performed using the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the technique 800 may be performed using any other suitable device(s) and in any other suitable system(s), and the technique 800 may be used to implement any other suitable process(es) and architecture(s) designed in accordance with this disclosure.

As shown in FIG. 8, eye gaze vectors 702 and 704 towards the target point 214 change with changes in eye relief. For example, suppose the designed eye relief of the electronic device 101 is d_{eye} and the user changes their eye position to have a new eye relief

$${d}_{eye}^{′} ,$$

where the change In eye position

$${δ}_{{d}_{eye}} = {d}_{eye}^{′} - {d}_{eye} .$$

In some cases, the change in eye position may be determined as part of user eye relief identification function 630. In this circumstance, the gaze target focal distance changes from d_{f} to

$${d}_{f}^{′} ,$$

such that the change in focal distance

$${δ}_{{d}_{f}} = {d}_{f}^{′} - {d}_{f} .$$

Because the eye relief changes, the eye gaze vectors 702 and 704 change, causing a parallax change that could be expressed as follows.

$$\{ \begin{matrix}{p}_{l}^{′} ← {p}_{l} \\ {p}_{r}^{′} ← {p}_{r}\end{matrix}$$

Although FIG. 8 illustrates one example of a technique 800 for computing eye relief changes, various changes may be made to FIG. 8. For example, the designed eye relief d_{eye} could be longer than the new eye relief

$${d}_{eye}^{′} .$$

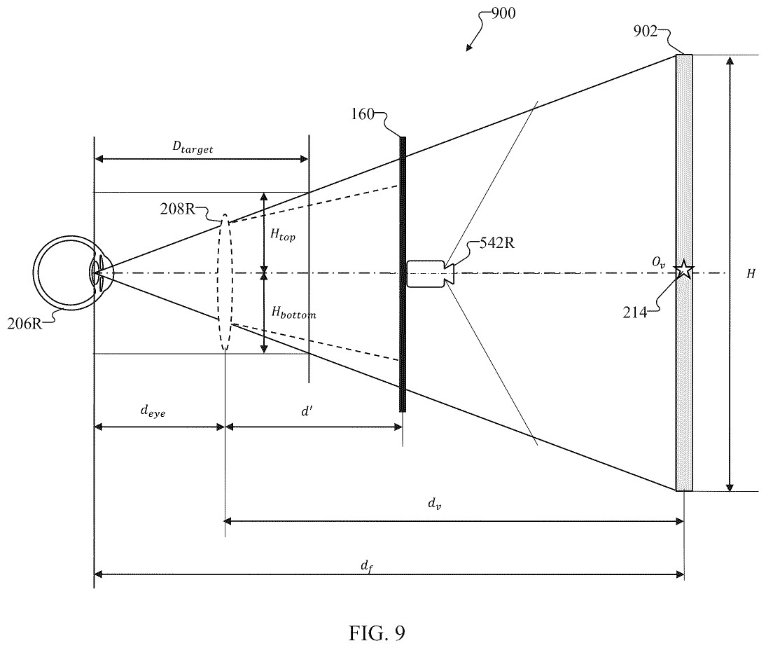

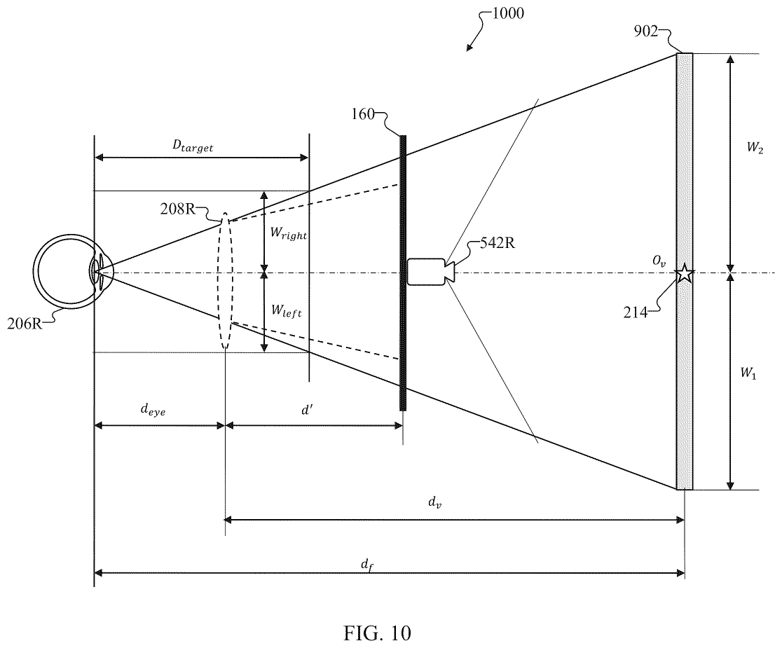

FIGS. 9 and 10 illustrate example relationships 900 and 1000 between virtual images and eye relief in accordance with this disclosure. For ease of explanation, the relationships 900 and 1000 shown in FIGS. 9 and 10 are described as being used by the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the relationships 900 and 1000 may be used by any other suitable device(s) and in any other suitable system(s), and the relationships 900 and 1000 may be used in any other suitable process(es) and architecture(s) designed in accordance with this disclosure.

As shown in FIGS. 9 and 10, the user's eye 206R is viewing a scene that includes a target point P associated with a gaze target 214. The target point P is located on an image plane 902. A see through camera 542R is used to capture image frames of the scene, and the see-through cameras 542R can capture the image frames at image plane 902 associated with the see-through camera 452. One or more displays 160 present rendered images to the user, and the one or more displays 160 are viewed by the user through display lens 208R. The display lens 208R focuses the rendered images onto image plane 902 that are viewed by the user's eye 206R. FIG. 9 shows the relationship between the virtual image vertical field of view with the eye relief, while FIG. 10 shows the relationship between the virtual image horizontal field of view with the eye relief.

In the example shown in FIG. 9, the relationships Hₜₒₚ and H_{bottom} can be obtained, where

$${H}_{top} = {D}_{target} \frac{H}{2 ( {d}_{f} + {d}_{eye} )} and {H}_{bottom} = - {D}_{target} \frac{H}{2 ( {d}_{f} + {d}_{eye} )} .$$

Here, D_{target} represents the distance of the target plane, d_{f} represents the gaze focal distance, d_{eye} represents the eye relief, and H represents the height of the virtual image. In the example shown in FIG. 10, the relationships W_{right} and W_{left} can be obtained, where

$${W}_{right} = {D}_{target} \frac{{W}_{2}}{2 ( {d}_{f} + {d}_{eye} )} and {W}_{left} = - {D}_{target} \frac{{W}_{1}}{2 ( d + {d}_{e y e} )} .$$

Here, w₁ and w₂ represent partial widths.

Because of these relationships, eye relief changes can cause field of view changes and virtual image changes. It should be understood that while FIGS. 9 and 10 illustrate one example with reference to the user's eye 206R with respect to the see-through camera 542R, the same relationships can apply with reference to the user's eye 206L with respect to a see-through camera 542L. Using the relationships 900 and 1000, an actual eye relief distance of a user can be determined based on a known gaze focal distance d_{f} (which can be determined using eye tracking) and the dimensions of the virtual image.

Although FIGS. 9 and 10 illustrate examples of relationships 900 and 1000 between virtual images and eye relief, various changes may be made to FIGS. 9 and 10. For example, the specific positions of the see-through camera 542R relative to the user eye 206R is shown here are for illustration and explanation only and can vary as needed or desired.

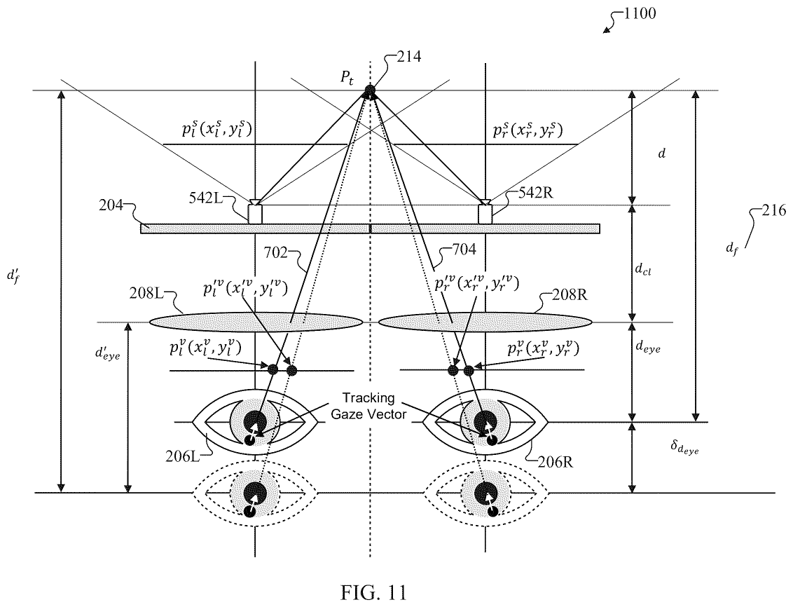

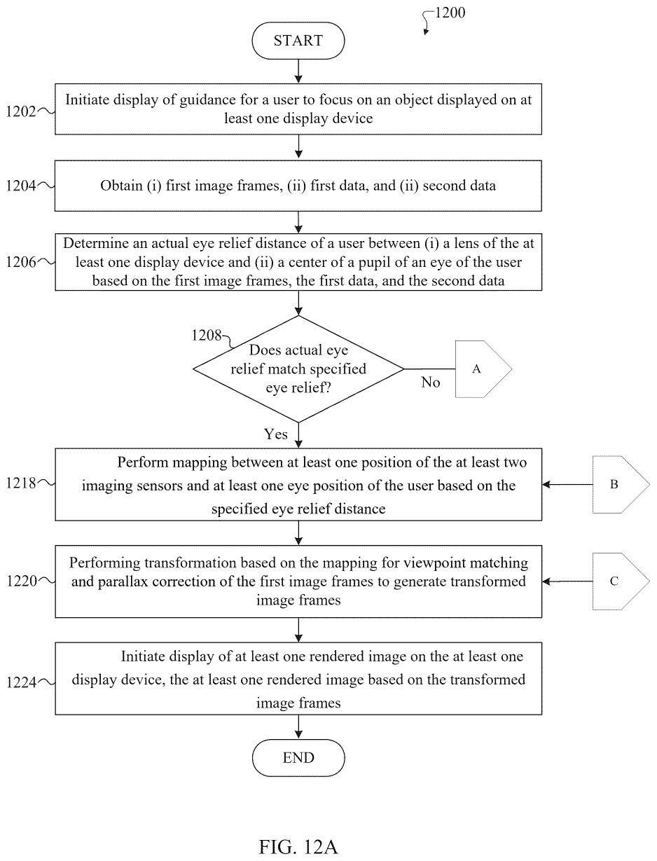

FIG. 11 illustrates an example technique 1100 for mapping between a see-through camera and a virtual camera with an eye relief change in accordance with this disclosure. For ease of explanation, the technique 1100 shown in FIG. 11 is described as being performed using the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the technique 1100 may be performed using any other suitable device(s) and in any other suitable system(s), and the technique 1100 may be used to implement any other suitable process(es) and architecture(s) designed in accordance with this disclosure.

As shown in FIG. 11, a new mapping may be formed (such as when done as part of the mapping creation function 646) between see-through frames and the eye view frames considering an eye relief change similar as described regarding FIG. 8. For example, assume that a user of the electronic device 101 uses the electronic device 101 with a designed eye relief d_{eye} and that the gaze target focal distance is d_{f} In this circumstance, the mapping between the left see-through camera 542L and the left eye view virtual camera can be determined as follows.

$$\{ \begin{matrix}{x}_{l}^{v} = \frac{d}{{d}_{f}} {x}_{l}^{s} \\ {y}_{l}^{v} = \frac{d}{{d}_{f}} {y}_{l}^{s}\end{matrix}$$

### Here,

$${p}_{l}^{v} ( {x}_{l}^{v} , {y}_{l}^{v} )$$

represents a pixel on a left virtual frame,

$${p}_{l}^{s} ( {x}_{l}^{s} , {y}_{l}^{s} )$$

represents a pixel on the left see-through frame, d represents the depth of the designed gaze target, and d_{f} represents the gaze target focal distance (which includes the designed eye relief d_{eye} such that d_{f}=d+d_{ci}+d_{eye}). Similarly, the mapping between the right see-through camera 542R and the left eye view virtual camera can be determined as follows.

$$\{ \begin{matrix}{x}_{r}^{v} = \frac{d}{{d}_{f}} {x}_{r}^{s} \\ {y}_{r}^{v} = \frac{d}{{d}_{f}} {y}_{r}^{s}\end{matrix}$$

### Here,

$${p}_{r}^{v} ( {x}_{r}^{v} , {y}_{r}^{v} )$$

represents a pixel on the right virtual frame, and

$${p}_{r}^{s} ( {x}_{r}^{s} , {y}_{r}^{s} )$$

represents a pixel on the right see-through frame.

When the eye relief changes from d_{eye} to

$${d}_{eye}^{′}$$

and the change is δ_{d}_{_{eye}}, the gaze target focal distance changes from d_{f} to

$${d}_{f}^{′} , where {d}_{f}^{′} = {d}_{f} + {δ}_{{d}_{eye}} and {d}_{f}^{′} = d + {d}_{cl} + {d}_{eye}^{′} .$$

A new mapping between the left see-through camera pixel

$${p}_{l}^{s} ( {x}_{l}^{s} , {y}_{l}^{s} )$$

and the left eye view virtual camera pixel

$${p}_{l}^{′ v} ( {x}_{l}^{′ v} , {y}_{l}^{′ v} )$$

may be banned as follows.

$$\{ \begin{matrix}{x}_{l}^{′ v} = \frac{d}{{d}_{f}^{′}} {x}_{l}^{s} \\ {y}_{l}^{′ v} = \frac{d}{{d}_{f}^{′}} {y}_{l}^{{s}^{′}}\end{matrix}$$

Similarly, a new mapping between the right see-through camera pixel

$${p}_{r}^{s} ( {x}_{r}^{s} , {y}_{r}^{s} )$$

and the right eye view camera pixel

$${p}_{r}^{′ v} ( {x}_{r}^{′ v} , {y}_{r}^{′ v} )$$

may be turned as follows.

$$\{ \begin{matrix}{x}_{r}^{′ v} = \frac{d}{{d}_{f}^{′}} {x}_{r}^{s} \\ {y}_{r}^{′ v} = \frac{d}{{d}_{f}^{′}} {y}_{r}^{s}\end{matrix}$$

Although FIG. 11 illustrates one example of a technique 1100 for mapping between a see-through camera and a virtual camera with an eye relief change, various changes may be made to FIG. 11. For example, the designed eye relief d_{eye} could be longer than the new eye relief

$${d}_{eye}^{′} .$$

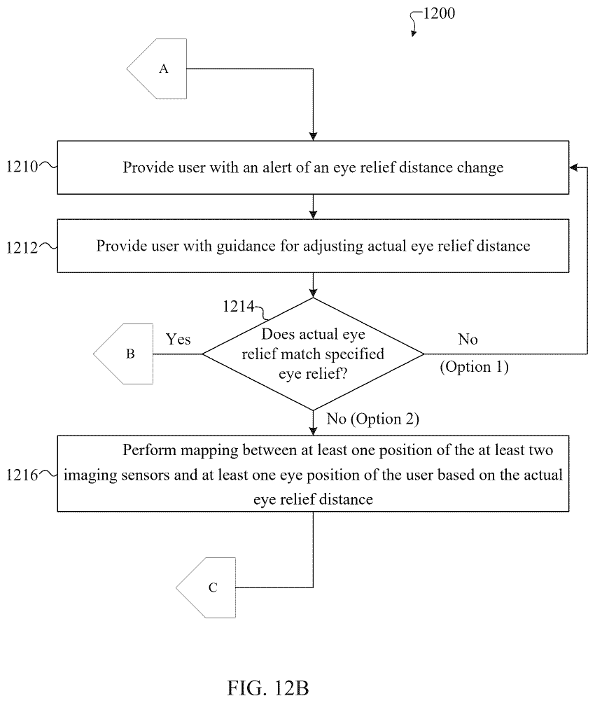

FIGS. 12A and 12B illustrate an example method 1200 for adaptive eye relief verification and new mapping for VST XR or other applications in accordance with this disclosure. For ease of explanation, the method 1200 shown in FIGS. 12A and 12B is described as being performed using or as involving the use of the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the method 1200 may be performed using any other suitable device(s) and in any other suitable system(s), and the method 1200 may be implemented using any other suitable process(es) and architecture(s) designed in accordance with this disclosure.

As shown in FIG. 12, an electronic device (such as electronic device 101) initiates display of guidance for a user to focus on an object displayed on at least one display device at step 1202. This may include, for example, the processor 120 of the electronic device 101 presenting one or more rendered images or videos to a user 202 on at least one display 160 of the electronic device 101. The one or more rendered images or videos could include at least one object, point, or pattern on which the user 202 focuses his or her eyes 206L and 206R.

The electronic device obtains first image frames, first data, and second data at step 1204. This may include, for example, the processor 120 of the electronic device 101 obtaining image frames of a physical environment with two or more see-through cameras 542L and 542R. This may also include the processor 120 of the electronic device 101 obtaining image frames of the user's eyes 206L and 206R from the eye-tracking imaging sensors 304 while the user 202 is focusing his or her eyes 206L and 206R on the displayed object, point, or pattern. This may further include the processor 120 of the electronic device 101 obtaining image frames from an object tracking camera separate from the imaging sensors. In some embodiments, the object tracking camera could be a physical camera similar to see-through cameras 542L and 542R tracking an object in a physical environment. In other embodiments, the object tracking camera could be a virtual camera tracking a virtual object in a rendered environment.

An actual eye relief distance of the user between a lens of the at least one display device and a center of a pupil of an eye of the user is determined based on the image frames, first data, and second data at step 1206. This may include, for example, the processor 120 of the electronic device 101 deriving the eye relief distance based on relationships 900 and 1000 from the image frames, the first data, and the second data. In some cases, this may include determining gaze vectors of a left eye and a right eye of the user based on the first data and determining whether the user is focusing on an object based on the gaze vectors. The electronic device 101 may determine the actual eye relief distance once it has been determined that the user is focusing on the object. In some embodiments, a position of the object may be determined based on the second data, and the eye relief distance may be determined based on the gaze vectors and the position of the object. In some embodiments, the electronic device 101 may determine a focal distance of the left and right eyes of the user to the object based on the gaze vectors and the second data.

The actual eye relief distance is compared to a specified eye relief distance of the electronic device at step 1208. This may include, for example, the processor 120 of the electronic device 101 comparing the actual eye relief distance to a design eye relief distance of the electronic device 101 or a previously-saved eye relief setting of the electronic device 101. In response to a determination that the actual eye relief distance does not match the specified eye relief distance, the electronic device provides the user with an alert of an eye relief distance change at step 1210. This may include, for example, the processor 120 of the electronic device 101 providing an audible or visual alert using the alert generation function 634. The electronic device may provide further guidance to the user to adjust the actual eye relief distance at step 1212. This may include, for example, the processor 120 of the electronic device 101 providing guidance for the user to manipulate a manual control on the electronic device 101. Also or alternatively, the electronic device 101 may instruct the user to hold a position while the electronic device 101 automatically adjusts the eye relief distance, such as by using one or more actuators.

The actual eye relief distance is again compared to a specified eye relief distance of the electronic device at step 1214. If the actual eye relief distance and the specified eye relief distance do not match (such as when the difference between the actual eye relief distance and the specified eye relief distance exceeds a threshold), the method 1200 may revert to step 1210 (option 1) or proceed to step 1216 (option 2). For example, option 1 may apply if the actual eye relief distance and the specified eye relief distance do not match but a number of adjustment attempts are below a threshold (such as based on an attempt counter) or if some adjustment range is still available for the electronic device 101 (such as based on a measurement or a sensor output). Option 2 may apply if the actual eye relief distance and the specified eye relief distance do not match but a number of adjustment attempts are above a threshold or if the adjustment range for the electronic device 101 is at an adjustment limit.

If the actual eye relief still does not match the specified eye relief after at least one adjustment, the electronic device performs mapping between at least one position of the at least two imaging sensors and at least one eye position of the user based on the actual eye relief distance at step 1216. This may include, for example, the processor 120 of the electronic device 101 determining the mapping using the technique 1100, where a new mapping is performed based on a measured focal distance change between the specified eye relief distance and the actual eye relief distance. If the actual eye relief matches the specified eye relief, the electronic device performs mapping between at least one position of the at least two imaging sensors and at least one eye position of the user based on the specified eye relief distance at step 1218. This may include, for example, the processor 120 of the electronic device 101 determining the mapping according to a previously-determined eye relief distance, such as a designed eye relief distance or a previously-saved or determined eye relief distance.

The electronic device performs transformation based on the mapping for viewpoint matching and parallax correction of the first image frames to generate transformed image frames at step 1220, and the resulting transformed image frames can be rendered for presentation at step 1222. This may include, for example, the processor 120 of the electronic device 101 applying translations, rotations, or other transformations based on the retrieved or generated mapping(s) and rendering the resulting transformed image frames.

Although FIGS. 12A and 12B illustrate one example of a method 1200 for adaptive eye relief verification and new mapping for VST XR or other applications, various changes may be made to FIGS. 12A and 12B. For example, while shown as a series of steps, various steps in FIGS. 12A and 12B may overlap, occur in parallel, occur in a different order, or occur any number of times (including zero times).

It should be noted that the functions shown in or described with respect to FIGS. 2 through 12B can be implemented in an electronic device 101, 102, 104, server 106, or other device(s) in any suitable manner. For example, in some embodiments, at least some of the functions shown in or described with respect to FIGS. 2 through 12B can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 12B can be implemented or supported using dedicated hardware components. In general, the functions shown in or described with respect to FIGS. 2 through 12 can be performed using any suitable hardware or any suitable combination of hardware and software/firmware instructions. Also, the functions shown in or described with respect to FIGS. 2 through 12 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
initiating, using at least one processing device of an electronic device, display of guidance for a user to focus on an object displayed on at least one display device of the electronic device;
obtaining, using the at least one processing device, (i) first image frames using at least two imaging sensors of the electronic device, (ii) first data using at least one eye-tracking sensor of the electronic device, and (iii) second data using at least one object tracking camera of the electronic device;
determining, using the at least one processing device, an actual eye relief distance of the user between (i) a lens of the at least one display device and (ii) a center of a pupil of an eye of the user, the actual eye relief distance based on the first image frames, the first data, and the second data; and
determining, using the at least one processing device, whether the actual eye relief distance matches a specified eye relief distance of the electronic device.

2. The method of claim 1, further comprising, in response to a determination that the actual eye relief distance does not match the specified eye relief distance:
providing the user with an alert of an eye relief distance change;
providing the user with guidance for adjusting the actual eye relief distance; and
after an adjustment of the actual eye relief distance:
redetermining the actual eye relief distance; and
determining whether the redetermined actual eye relief distance matches the specified eye relief distance.

3. The method of claim 2, further comprising, in response to a determination that the redetermined actual eye relief distance does not match the specified eye relief distance:
performing a mapping between at least one position of the at least two imaging sensors and at least one eye position of the user based on the actual eye relief distance;
performing a transformation based on the mapping for viewpoint matching and parallax correction of the first image frames to generate transformed image frames; and
initiating display of at least one rendered image on the at least one display device, the at least one rendered image based on the transformed image frames.

4. The method of claim 1, further comprising, in response to a determination that the actual eye relief distance matches the specified eye relief distance:
performing a mapping between at least one position of the at least two imaging sensors and at least one eye position of the user based on the specified eye relief distance;
performing a transformation based on the mapping for viewpoint matching and parallax correction of the first image frames to generate transformed image frames; and
initiating display of at least one rendered image on the at least one display device, the at least one rendered image based on the transformed image frames.

5. The method of claim 1, further comprising:
determining gaze vectors of a left eye and a right eye of the user based on the first data; and
determining whether the user is focusing on the object based on the gaze vectors;
wherein the actual eye relief distance is determined in response to a determination that the user is focusing on the object.

6. The method of claim 1, further comprising:
determining gaze vectors of a left eye and a right eye of the user based on the first data; and
determining a position of the object based on the second data;
wherein the actual eye relief distance is determined based on the gaze vectors and the position of the object.

7. The method of claim 6, further comprising:
determining a focal distance of the left and right eyes of the user to the object based on the gaze vectors and the second data.

8. An electronic device comprising:
at least one processing device configured to:
initiate display of guidance for a user to focus on an object displayed on at least one display device of the electronic device;
obtain (i) first image frames using at least two imaging sensors of the electronic device, (ii) first data using at least one eye-tracking sensor of the electronic device, and (iii) second data using at least one object tracking camera of the electronic device;
determine an actual eye relief distance of the user between (i) a lens of the at least one display device and (ii) a center of a pupil of an eye of the user, the actual eye relief distance based on the first image frames, the first data, and the second data; and
determine whether the actual eye relief distance matches a specified eye relief distance of the electronic device.

9. The electronic device of claim 8, wherein the at least one processing device is further configured, in response to a determination that the actual eye relief distance does not match the specified eye relief distance, to:
provide the user with an alert of an eye relief distance change;
provide the user with guidance for adjusting the actual eye relief distance; and
after an adjustment of the actual eye relief distance:
redetermine the actual eye relief distance; and
determine whether the redetermined actual eye relief distance matches the specified eye relief distance.

10. The electronic device of claim 9, wherein the at least one processing device is further configured, in response to a determination that the redetermined actual eye relief distance does not match the specified eye relief distance, to:
perform a mapping between at least one position of the at least two imaging sensors and at least one eye position of the user based on the actual eye relief distance;
perform a transformation based on the mapping for viewpoint matching and parallax correction of the first image frames to generate transformed image frames; and
initiate display of at least one rendered image on the at least one display device, the at least one rendered image based on the transformed image frames.

11. The electronic device of claim 8, wherein the at least one processing device is further configured, in response to a determination that the actual eye relief distance matches the specified eye relief distance, to:
perform a mapping between at least one position of the at least two imaging sensors and at least one eye position of the user based on the specified eye relief distance;
perform a transformation based on the mapping for viewpoint matching and parallax correction of the first image frames to generate transformed image frames; and
initiate display of at least one rendered image on the at least one display device, the at least one rendered image based on the transformed image frames.

12. The electronic device of claim 8, wherein the at least one processing device is further configured to:
determine gaze vectors of a left eye and a right eye of the user based on the first data; and
determine whether the user is focusing on the object based on the gaze vectors;
wherein the actual eye relief distance is determined in response to a determination that the user is focusing on the object.

13. The electronic device of claim 8, wherein the at least one processing device is further configured to:
determine gaze vectors of a left eye and a right eye of the user based on the first data; and
determine a position of the object based on the second data;
wherein the actual eye relief distance is determined based on the gaze vectors and the position of the object.

14. The electronic device of claim 13, wherein the at least one processing device is further configured to determine a focal distance of the left and right eyes of the user to the object based on the gaze vectors and the second data.

15. A non-transitory machine readable medium containing instructions that when executed cause at least one processor of an electronic device to:
initiate display of guidance for a user to focus on an object displayed on at least one display device of the electronic device;
obtain (i) first image frames using at least two imaging sensors of the electronic device, (ii) first data using at least one eye-tracking sensor of the electronic device, and (iii) second data using at least one object tracking camera of the electronic device;
determine an actual eye relief distance of the user between (i) a lens of the at least one display device and (ii) a center of a pupil of an eye of the user, the actual eye relief distance based on the first image frames, the first data, and the second data; and
determine whether the actual eye relief distance matches a specified eye relief distance of the electronic device.

16. The non-transitory machine readable medium of claim 15, further containing instructions that when executed cause the at least one processor, in response to a determination that the actual eye relief distance does not match the specified eye relief distance, to:
provide the user with an alert of an eye relief distance change;
provide the user with guidance for adjusting the actual eye relief distance; and
after an adjustment of the actual eye relief distance:
redetermine the actual eye relief distance; and
determine whether the redetermined actual eye relief distance matches the specified eye relief distance.

17. The non-transitory machine readable medium of claim 16, further containing instructions that when executed cause the at least one processor, in response to a determination that the redetermined actual eye relief distance does not match the specified eye relief distance, to:
perform a mapping between at least one position of the at least two imaging sensors and at least one eye position of the user based on the actual eye relief distance;
perform a transformation based on the mapping for viewpoint matching and parallax correction of the first image frames to generate transformed image frames; and
initiate display of at least one rendered image on the at least one display device, the at least one rendered image based on the transformed image frames.

18. The non-transitory machine readable medium of claim 15, further containing instructions that when executed cause the at least one processor, in response to a determination that the actual eye relief distance matches the specified eye relief distance, to:
perform a mapping between at least one position of the at least two imaging sensors and at least one eye position of the user based on the specified eye relief distance;
perform a transformation based on the mapping for viewpoint matching and parallax correction of the first image frames to generate transformed image frames; and
initiate display of at least one rendered image on the at least one display device, the at least one rendered image based on the transformed image frames.

19. The non-transitory machine readable medium of claim 15, further containing instructions that when executed cause the at least one processor to:
determine gaze vectors of a left eye and a right eye of the user based on the first data; and
determine whether the user is focusing on the object based on the gaze vectors;
wherein the actual eye relief distance is determined in response to a determination that the user is focusing on the object.

20. The non-transitory machine readable medium of claim 15, further containing instructions that when executed cause the at least one processor to:
determine gaze vectors of a left eye and a right eye of the user based on the first data;
determine a position of the object based on the second data; and
determine a focal distance of the left and right eyes of the user to the object based on the gaze vectors and the second data;
wherein the actual eye relief distance is determined based on the gaze vectors and the position of the object.
